(19) United States
(12) Patent Application Publication
(10) Pub. No.: US 2007/0065775 A1
(43) Pub. Date: Mar. 22, 2007

(54) Device for removably fixing and driving a dental instrument in the head of a handpiece

(76) Inventor: Jean-Marie Badoz, Doubs (FR)

Correspondence Address: Gary M Cohen, Strafford Building Number Three, 125 Strafford Avenue Suite 300, Wayne, PA, 19087-3318, US

(21) Appl. No.: 10/575,591

(22) PCT Filed: Jul. 20, 2004
(86) PCT No.: PCT/FR04/01913

§ 371 Date: Apr. 12, 2006

(30) Foreign Application Priority Data
Nov. 5, 2003 (FR) 03/12958

(51) Int. Cl. A61C 1/14

(52) U.S. Cl. 433/127

(57) ABSTRACT

A device for removably fixing a tooth tool (4) to a head (3) of a handpiece (1), said handpiece (1) being formed by a handle (5), a neck (2) and a head (3), each of these parts being provided in its inside with a drive shaft (6), characterized in that said tool (4) is disposed in a bore (7) formed in the head (3) of the handpiece (1), and in that it is held inside said bore (7) by the contact with the drive shaft (6).

The present invention relates to a device for removably fixing and driving a tooth tool in the head of a handpiece, also called a contra-angle.

This invention applies to the field of dental handpieces or contra-angles, and more particularly to the field of devices for removably fixing tooth tools to the handpieces.

The tooth tools intended to be used on handpieces are generally provided with shanks complying with ISO 1797.

There are many means available for removably fixing the tooth tools to the handpieces, in particular in the patent EP 0 174 695 filed by the present applicant, describing a device that allows the tooth tool to be fixed axially.

This type of device permits good fixing and good rotation of the tooth tool, but has the disadvantage of taking up considerable space, which obstructs the practitioner's view.

Rapid developments are presently taking place in the field of dentistry performed under a microscope. It is therefore essential for the practitioner to have maximum visibility and accessibility, hence the need for fixing and driving means that take up as little space as possible.

This applies to dentistry performed under a microscope, but it also applies to conventional dental work carried out by direct sight, since the view of the teeth and the access to them are better, the smaller the space taken up by the driving and fixing means. This is particularly the case in endodontic treatments of the back teeth.

The invention aims to overcome these various disadvantages by making available a device for removably fixing and driving tooth tools on a handpiece of small size, permitting in particular the formation of contra-angle heads of very small dimension that are able to receive standard shanks.

To this end, the subject of the present invention is a device for removably fixing a tooth tool to a head of a handpiece, said handpiece being formed by a handle, a neck and a head, each of these parts being provided in its inside with a drive shaft, characterized in that said tool is disposed in a bore formed in the head of the handpiece, and in that it is held inside said bore by the contact with the drive shaft.

The invention will be better understood with reference to the attached drawings, in which:

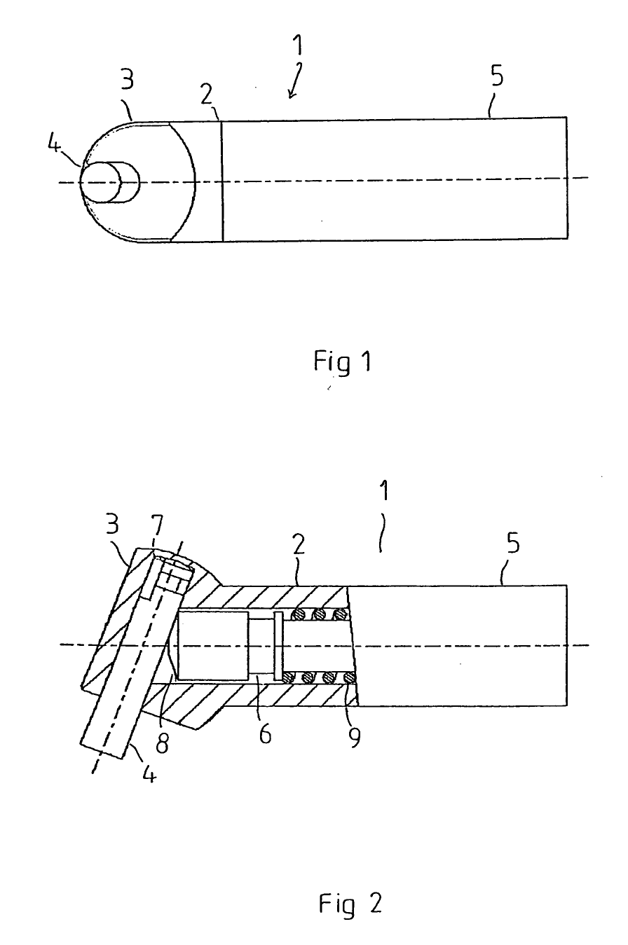

FIG. 1 is a bottom view of the handpiece according to a first embodiment of the invention,

FIG. 2 is a cross-sectional view of the handpiece in which the tooth tool is fitted according to a first embodiment of the invention,

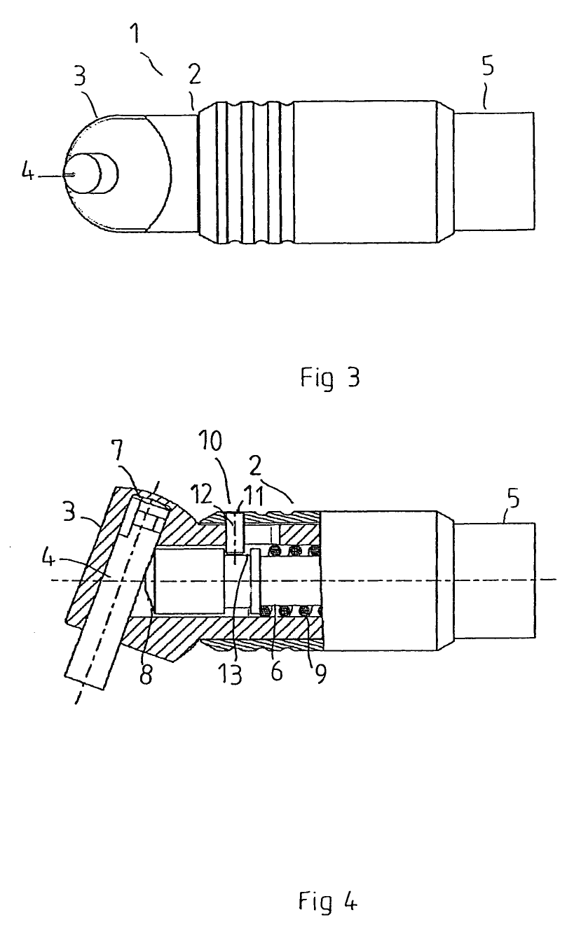

FIG. 3 is a bottom view of a second embodiment of the handpiece with an external system for disengagement of the drive shaft,

FIG. 4 is a cross-sectional view of the second embodiment of the handpiece according to the invention.

The handpieces (1) or contra-angles are generally made up of an anterior part or neck (2) of cylindrical/conical outer shape supporting the head (3) in which the tooth tool (4) is fixed, and of a handle (5) having a shape which is substantially cylindrical and/or conical in revolution.

Each of these parts is provided in its inside with a drive shaft (6) ensuring the rotation of the tooth tool (4).

The shank of the tooth tool (4) fits in the head (3) of the handpiece in a bore (7) formed in the transverse axis of the head (3).

The shank of the tooth tool (4) is in direct contact with one of the ends of the drive shaft (6), thus ensuring rotation of the tool (4).

The point of contact between the shank of the tool (4) and the drive shaft (6) is situated in the area of a gear (8).

This gear (8) will preferably be inclined on the sides in order to match the shape of the tool (4).

Furthermore, this inclination of the gear (8) also allows the tool (4) to be pushed to the bottom of the bore (7) during rotation of this tool (4), thus permitting good fixing of the latter.

Moreover, if the point of contact between the drive shaft (6) and the tool (4) is offset, the mechanical forces of the rotation push the instrument toward the bottom of the head (3), thus avoiding the risk of the tool (4) escaping.

According to an advantageous characteristic of the invention, the drive shaft (6) is provided with a rubber shroud, ensuring the rotation movement. These rotation movements will be of the friction type.

According to a first embodiment, the drive shaft is provided with a spring device (9) in the area of the handle (5). This device (9) is situated on the upper face of the drive shaft (6). It ensures the tool can be fitted in place by simple pushing of the drive shaft (6).

Thus, when the tooth tool (4) is introduced into the bore (7) of the head (3) of the handpiece (1), it pushes on the drive shaft (6), which draws back by way of this spring device (9).

Likewise, upon disengagement of the tool (4) from the head (3) of the handpiece (1), the drive shaft (6) is pushed toward the front of the head (3) by this spring device (9).

According to a second embodiment of the device according to the invention, in order to disengage the drive shaft (6) from the head (3) of the handpiece (1), the latter can be provided with a device (10) controlling the engagement or disengagement of the tooth tool (4).

This device is situated on the outer upper face in the area of the neck (2) of the handpiece (1). It is formed by a ring (11) placed on the neck (2) of the handpiece (1).

This ring (11) is provided with a stub (12) which drives the shaft (6) in the direction of disengagement by virtue of a groove (13) situated in the shaft (6).

The drive shaft (6) engages in the head (3) by virtue of the spring device (9) described above in connection with the first embodiment of the invention.

The drive shaft (6) is situated in a longitudinal axis in relation to the handpiece (1), in contrast to the axis of the bore (7) receiving the tool (4), which axis is a transverse axis. These differences in plane allow the tool (4) to fit securely at the bottom of the bore (7) by virtue of the forces created by the drive shaft (6) during its rotation. This is accentuated by the gear (8) situated at the end of the shaft (6) in contact with the tool (4).

Moreover, these differences in plane allow the drive shaft (6) to be fitted with slight play. During its rotation, the shaft (6) is then situated in an offset position relative to the tool (4). This offset pushes the tool (4) to the bottom of the head (3), thereby avoiding escape of said tool (4).

Moreover, to ensure that this device functions both in rightward rotation and leftward rotation, it suffices to give the axis of the drive shaft (6) some play in its seat in such a way that it independently takes up an offset position during the rotation.

Although the invention has been described on the basis of specific parts, it comprises all technical equivalents of the parts described.

1. A device for removably fixing a tooth tool (4) to a head (3) of a handpiece (1), said handpiece (1) being formed by a handle (5), a neck (2) and a head (3), each of these parts being provided in its inside with a drive shaft (6), characterized in that said tool (4) is disposed in a bore (7) formed in the head (3) of the handpiece (1), and in that it is held inside said bore (7) by the contact with the drive shaft (6).

2. The device for removable fixing as claimed in claim 1, characterized in that the drive shaft (6) is surrounded by a rubber shroud.

3. The device for removable fixing as claimed in one of the preceding claims, characterized in that the drive shaft (6) is provided with a device forming a spring in the area of the handle (5) of the handpiece (1)

4. The device for removable fixing as claimed in one of the preceding claims, characterized in that said handpiece (1) is equipped with a control device (10) allowing the tool (4) to be withdrawn from or engaged in the bore (7).

5. The device for removable fixing as claimed in claim 4, characterized in that the control device (10) is formed by a ring (11) placed on the neck (2) of the handpiece (1), said ring (11) being provided with a stub (12) that fits in a groove (13) formed in the drive shaft (6).

6. The device for removable fixing as claimed in one of the preceding claims, characterized in that the drive shaft (6) is provided with a gear (8) at the end in contact with the tooth tool (4).

7. The device for removable fixing as claimed in claim 6, characterized in that the gear (8) is inclined on its sides.

8. The device for removable fixing as claimed in one of the preceding claims, characterized in that the bore (7), receiving the tool (4), and the drive shaft are situated in different axes.

9. The device for removable fixing as claimed in claim 8, characterized in that the drive shaft (6) is mounted in its seat with play, which allows it to be offset relative to the tooth tool (4) during its rotation.

10. The device for removable fixing as claimed in one of the preceding claims, characterized in that the point of contact between the drive shaft (6) and the tooth tool (4) is offset.
